(19) United States
(12) Patent Application Publication
(10) Pub. No.: US 2021/0035048 A1
(43) Pub. Date: Feb. 4, 2021

(54) SYSTEMS AND METHODS FOR PROJECT AND SKILL-SET VERIFICATION

(71) Applicant: MOONLIGHT.IO PRIVATE LIMITED, SINGAPORE (SG)

(72) Inventors: Tyler Benjamin ADAMS, Fort Collins, CO (US); Alan FONG, Ann Arbor, MI (US); Chris BIRMINGHAM, Chiswick (AU); Benjamin Peter HALLOWES, Marlow (GB)

(21) Appl. No.: 16/965,417

(22) PCT Filed: Jan. 29, 2019
(86) PCT No.: PCT/US2019/015713

§ 371 Date: Jul. 28, 2020

Related U.S. Application Data
(60) Provisional application No. 62/623,719, filed on Jan. 30, 2018.
(60) Provisional application No. 62/637,322, filed on Mar. 1, 2018.

(51) Int. Cl. G06Q 10/06; G06F 9/54; H04L 9/32

(52) U.S. Cl. CPC G06Q 10/063112; G06Q 10/063114; H04L 2209/38; G06F 9/547; H04L 9/3239; G06Q 10/06398

(57) ABSTRACT

An electronic device and a plurality of electronic devices can provide for database management systems and related methods. The database management system can provide a secure, verifiable record of saved information. The database management system can prevent post-fact tampering of the verified record, and can provide for access to the verified record.

### FIELD OF ART

Aspects of the present invention are directed to database management systems and related methods and more particularly to resource databases.

### BACKGROUND

Databases and methods of updating databases for projects and skillsets continue to heavily reliant on pre-digital methods for generating and updating data. As a result, even in the digital age, hiring workers is still heavily reliant on pre-digital methods for staffing. For employers, they will often publish a job posting or listing with a list of ideal skillsets and experience for the desired position.

Often, employers will compile their own internal database of potential candidates or they may access an external database of potential candidates. The employer can use filters to compare data information of the potential candidates in the databases to compare them to the employer's ideal skillsets and experience for a job posting.

However, the conventional databases merely provide access to the data information of the potential candidates as provided by the potential candidates. The data information is not modified by the employer but is merely retrieved by the employer as provided by the potential candidate. In this way, the conventional databases are merely digital versions of the traditional paper resume or curriculum vitae.

Further to this type of conventional resume consideration process, the conventional job postings are usually for joining specific departments or working groups based on a specific background of the potential candidate, whether by work experience or academic experience.

Project staffing in businesses is often based on experience or technical expertise. To aid in this, businesses are often structured such that departments and sub-groups are formed with specific expertise. This can be seen in businesses with departments such as research & development, manufacturing, marketing, human resources, legal, and technical support.

The conventional method of employment hiring candidates to join departments and sub-groups based on their self-provided data information continues to be the way that employers operate in the digital age.

### SUMMARY

One or more embodiments of the present application provide for a database management system for organizing and storing task information. The system can include at least one processor configured to execute computer-readable instructions and at least one non-transitory computer readable medium to provide a database management system.

The database management system can be directed to perform steps including generating a task for bidding by a resolver, receiving a bid from the resolver, retrieving data corresponding to previous tasks completed by the resolver from a database, accepting the bid from the resolver, and assigning the task to the resolver.

The database management system can further be directed to perform steps including receiving indication of completion of the task, and creating a data entry in the database corresponding to the task containing information relating to its completion.

Embodiments of the database management system can include wherein the database is a blockchain.

In some embodiments, the database management system can include wherein the task comprises at least one of a task value for completion, a listing of specific activities to be performed, and required skills for completion of the task.

Embodiments of the database management system can include wherein the bids can include at least one of an estimated time duration to completion of the task and a task value requested by the resolver to accept the task.

In some embodiments, the database management system can include wherein the data corresponding to previous tasks includes bidding information, a time duration to completion, a review of the resolver, and skills gained or improved by the task.

Embodiments of the database management system can include wherein the data entry in the database corresponding to the task includes bidding information, a time duration to completion, a review of the resolver, and skills gained or improved by the task.

In some embodiments, the database management system can include wherein the data entry includes a unique identifier to denote the resolver for user tracking when analyzing a blockchain.

Embodiments of the database management system can include wherein the data entry uniquely corresponds with the task.

In some embodiments, the database management system can include wherein the database management system can access the blockchain through an application programming interface (API).

Embodiments of the database management system can include wherein the database management system can compile activities and skills data from the data corresponding to previous tasks completed by the resolver. In some embodiments, the database management system can include wherein the database management system can generate a report or data record and save the report or data record to an external memory.

One or more embodiments of the present application provide for a method for database management for organizing and storing task information, generated by a database management system, to be performed by at least one processor and at least one non-transitory computer-readable medium to provide the database management system.

The method can include generating a task for bidding by a resolver, receiving a bid from the resolver, and retrieving data corresponding to previous tasks completed by the resolver from a database.

The method can include accepting the bid from the resolver and assigning the task to the resolver.

The method can include receiving indication of completion of the task, and creating a data entry in the database corresponding to the task containing information relating to its completion.

Embodiments of the database management system can include wherein the database is a blockchain.

In some embodiments, the database management system can include wherein the task comprises at least one of a task value for completion, a listing of specific activities to be performed, and required skills for completion of the task.

Embodiments of the database management system can include wherein the bids can include at least one of an estimated time duration to completion of the task and a task value requested by the resolver to accept the task.

In some embodiments, the database management system can include wherein the data corresponding to previous tasks includes bidding information, a time duration to completion, a review of the resolver, and skills gained or improved by the task.

Embodiments of the database management system can include wherein the data entry in the database corresponding to the task includes bidding information, a time duration to completion, a review of the resolver, and skills gained or improved by the task.

In some embodiments, the database management system can include wherein the data entry includes a unique identifier to denote the resolver for user tracking when analyzing a blockchain.

Embodiments of the database management system can include wherein the data entry uniquely corresponds with the task.

In some embodiments, the database management system can include wherein the database management system can access the blockchain through an application programming interface (API).

Embodiments of the database management system can include wherein the database management system can compile activities and skills data from the data corresponding to previous tasks completed by the resolver. Embodiments of the database management system can include wherein the database management system can generate a report or data record and save the report or data record to an external memory.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1A shows an example of an embodiment of an electronic device configured to operate in accordance with aspects of the present application.

FIG. 1B shows an example of an embodiment of a collection of electronic devices that may be utilized for database management with aspects of the present application.

FIG. 2 shows an example of a data structure wherein organization records are stored based on specific tasks completed rather than as summaries of prior experience.

FIG. 3 shows a chart of four different, organizational structures that are contemplated in the present database management system.

FIG. 4 shows example representations of how tasks in the ecosystem can be understood.

FIG. 5 shows a simplified diagram showing a ranked hierarchical network for skills.

FIG. 6 shows a representation of how the ecosystem can aid in evaluating the resolver organization's estimate in the task duration.

FIG. 7 shows an example representation of a staked remittance task.

FIG. 8 shows a representation of an embodiment where tasks can be optionally assigned relationships with other tasks to form a network diagram.

FIG. 9 shows a representation of an embodiment where a simulation can be provided for the expected completion time of the critical tasks.

FIG. 10 shows a representation of projections of the results of the simulation of FIG. 9 as a burndown plot.

FIG. 11 shows a representation of multiple bids and the associated time task durations of the bids for a task.

FIG. 12 shows a representation of multiple bids for a task, as in FIG. 11, reflected in projections of a simulation as a burndown plot.

FIG. 13 shows a representation of how resolver organizations can review their skill specific estimation bid accuracies as a mechanism for self-improvement over time.

FIG. 14 shows an example representation of the modular contract architecture of a blockchain platform for the ecosystem described.

FIG. 15 shows a flowchart as to how a database management system can provide the desired database structuring.

FIG. 16 shows a flowchart of how potential employers can also access the database management system to review the experience of a user.

### DETAILED DESCRIPTION

The detailed description set forth below in connection with the appended drawings is intended as a description of the presently preferred embodiments of systems, their components, and methods provided in accordance with aspects of the database generation and management for resource data and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

The present application provides a computer system capable of creating and updating database records of resource data in a secure manner with verification of the resource data. In this way, the database records can be more accurate than a database having mere reliance on external self-provided information.

The present application provides a database management system that can be used to organize records of experience of an individual or organization by tasks completed and skills associated with the tasks, rather than by generalized statements of skills of the individual or organization.

With traditional hiring methods through candidate updated databases, there is a follow-on problem from the conventional project staffing procedures in companies after a hired worker has been assigned to a particular department due to their specific skills.

Ultimately, this can result in idle and wasted resources for a company as well as an unmotivated work force. Upon hiring and assignment to a particular department, the individual worker is assigned to particular projects based on the particular department. In this way, the individual worker may feel pressured to focus on particular projects as determined by the department. Unfortunately, this can result in the worker not being able to utilize all of their skill-set, especially those outside of the usual demands of the department.

Passion projects and being able to work on projects that grow the worker's skill-set in desired areas can improve worker engagement. However, workers may not be able to work on passion projects due to resource compartmentalization when assigned to a particular department. Without the ability to grow in desired skillsets, workers can suffer from engagement issues as they work on department projects that do not interest them. Projects can thereby be impacted by engagement and staffing problems. Additionally, departments may have an excess idle labor buffer in the event that a project arises that requires a particular skillset or expertise. All of these concerns with staffing lead to a lot of management time spent attempting to optimize resources at the project, team, organization, and corporation levels.

The conventional hiring approaches are inherently limited due to the pre-digital mechanics used. Even using databases of candidates compiled electronically, the conventional hiring approach is relied upon. In conventional hiring methods, the employer will publish a job posting or listing with a desired skillset for a particular department. With long-term changes or directions in corporative initiatives, the desired skillset may only fulfill short-term organizational needs. Additionally, the posting of the job posting and culling of candidates can be resource intensive for the employer.

In this way, the conventional hiring approaches can result in product development and resourcing issues due to a lack of on-hand workers with relevant talent, who are unable to fulfill changing corporate needs. Previous surveying amongst companies has found that job postings took a 30 day median time to fill at a cost of $2000 per posting. Coupled with other concerns, including worker engagement issues, there was a median 15% annual employee turnover rate and Industry standard recruitment costs for knowledge workers are 20% of salary.

The conventional hiring approach is tied to these employment statistics. Conventionally, candidates to become workers respond to job postings with either physical or digital resumes highlighting their work experience. However, the mechanics of the job postings and resumes from candidates is dependent on trust and accuracy on the part of both parties. The employer must trust the honesty of the candidate's resume and the candidate is relying on accuracy of the job posting in tailoring the resume for the job posting. For employers, concern for the honesty of the resume of the candidate generally results in additional vetting or verification. This often presents itself in the form of a challenge during the interview process or contacting professional references. However, studies have shown that performance in challenges during interviews have little correlation to long term performance of the worker. Additionally, secondary investigations are often undertaken to verify the honesty of the resume. A common mechanic to verify general employment history and income is to perform a background check on the candidate.

However, even in view of general employment history, it can be difficult to evaluate a particular skill of the candidate. This issue can be particularly important in sectors or fields with specialized skills and limited numbers of candidates with sufficient experience. Although candidates may list some work experience with the specialized skills, it may be difficult to determine which candidates have sufficient working knowledge of the specialized skills to operate independently. For example, in the blockchain space currently, there is a limited number of qualified candidates and, similarly, a limited number of workers at an employer able to properly evaluate the skillset of the candidates. There can be a lot of time spent by investors identifying whether projects in the blockchain space can be trusted, and many projects encounter problems because they are missing critical resources.

Conventional databases cannot contemplate or account for these concerns. Instead, conventional databases for candidate pools only allow for candidate self-provided information relating to their experience and skillsets. This self-provided information can then be verified through interview challenges or secondary investigations. However, the conventional databases are merely statements based the totality of a candidate's prior experience. It can be difficult to actually determine the specific skills and knowledge of the candidate from a single sentence attempting to generally condense years of work experience.

Embodiments of the present application can provide for an integrated database for verified and secure resource management data. Instead of relying on candidate provided information, the database can generate and update information for specific skills for a candidate based on assigned tasks by a previous employer or the employer itself, if looking for candidates internally.

Embodiments of the database management system can be understood as having software components in the form of program code stored in non-transitory memory, and database records stored in non-transitory memory. The software components can comprise executable program code to configure hardware components, such as a processor, to perform operations or calculations. In embodiments, the database records can be in the form of a blockchain. In embodiments, the database management system can include hardware components uniquely configured for the database management system.

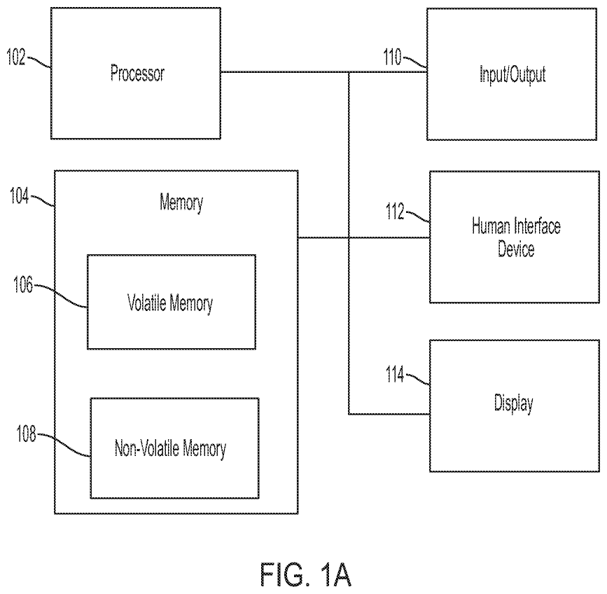

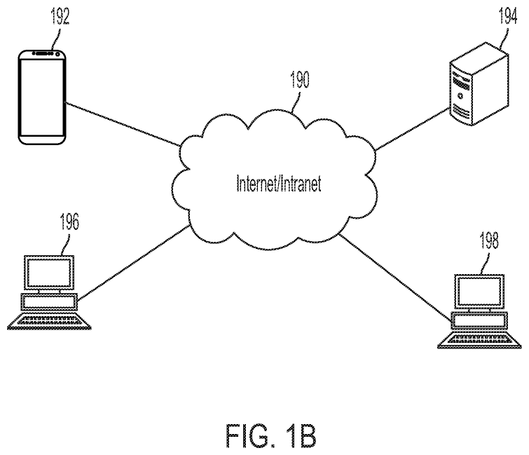

FIG. 1A illustrates an example of an embodiment of an electronic device 100 configured to operate in accordance with aspects of the present application. One of ordinary skill would understand the various configurations that the electronic device 100 can take the form of, including a personal computer, a server, a handheld device, or similar.

The electronic device 100 can comprise at least one processor 102, a non-transitory computer readable medium or memory 104, an input/output communication unit 110, a human interface device 112, and a display 114. Embodiments of the electronic device 100 can have various arrangements comprising only some of the above listed components.

The memory 104 can be a non-transitory computer readable medium. The memory 104 can comprise volatile memory 106 and non-volatile memory 108. The memory 104 can be a singular memory component or can be multiple discrete memory components. The volatile memory 106 and the non-volatile memory 108 can each be a singular memory component or can be multiple discrete memory components. In embodiments, the non-volatile memory 108 can be a cartridge, such as that which is known in console gaming systems, or a memory chip, such as PROM or EEPROM. The memory 104 can store program code executable by the processor 102. The program code can comprise instructions for implementing the database management of the present application.

In some embodiments, the electronic device 100 can further comprise removable memory. The removable memory can also store the program code executable by the processor 102. For example, the removable memory can be a portable flash drive or a portable hard drive. In embodiments, the removable memory can be a cartridge, such as that which is known in console gaming systems, or a memory chip, such as PROM or EEPROM. The removable memory can include alternative removable memory as would be understood by one of ordinary skill in the art.

The at least one processor 102 can be understood as a processing unit or device. The at least one processor can be a singular processor, a plurality of processors, a multi-core processor chip, or a combination of the foregoing. The at least one processor 102 can be configured to operate, execute, or perform operations based on program code stored in computer readable medium, such as the memory 104.

The input/output networking unit 110, or input/output networker, can be configured to send and receive information outside of the electronic device to another electronic device. The networking unit 110 can be hardware configured to allow data and software to be transferred externally of the electronic device. The networking unit 110 can be a modem, a networking card, a communication system, or other component.

The networking unit 110 can be connected to external devices by physical or wireless means. For example, a physical connection can be implemented by way of an Ethernet cable, a fiber optic cable, a coaxial cable, or other means. A wireless connection can be implemented by way of Wi-Fi®, WiMax®, radio, infrared, satellite signal, or other means.

The human interface device 112 can be understood as a device for allowing a user to operate and interact with the electronic device 100. The human interface device 112 can comprise at least one of a mouse, a keyboard, a touchscreen, or other known input means. In embodiments, the human interface device 112 can be physically connected to the electronic device or wirelessly connected to the electronic device 100. In embodiments, another electronic device can be connected to serve as a human interface device 112 to the electronic device 100, such as in a remote access set up.

The electronic device 100 can have a display 114 configured to display a user interface for viewing, inputting, and outputting data related to the database management. The display 114 can be configured to display data transferred between the electronic device 110 and external devices. Examples of the display 114 can include a liquid crystal display (LCD), a light emitting diode (LED) display, a thin film transistor (TFT) display, a cathode ray tube (CRT) display, or other similar. The display can be connected through a connection such as high definition multimedia interface (HDMI), DisplayPort®, digital visual interface (DVI), video graphics array (VGA), or other multimedia connections.

In embodiments, the processor 102 can be understood as having one or more modules or engines specifically configured to execute the program code. The modules or engines of the processor 102 can utilize hardware, software, or a combination, to implement the program code. It can be understood that the specific configuration of the processor can provide a specially configured electronic device 100 capable of uniquely executing the program code by way of the electronic device's unique structure.

In some embodiments, the electronic device 100 as understood can be as a server providing a particular virtual machine through virtualization. In such a case, a singular server could provide multiple instances of virtual machines providing the database management of the present application.

FIG. 1B illustrates an example of an embodiment of a collection of electronic devices that may be utilized for database management as described in the present application. In some embodiments, each of the individual electronic devices can store a full copy of the database. In some embodiments, one of the individual electronic devices can store only a part of the database.

Electronic devices can include a smartphone 192, a server 194, a personal computer 196, and a dedicated computing system 198, among other types of electronic devices, such as tablets, etc. The electronic devices can all be connected through the internet or an intranet 190.

In embodiments where the database management has a blockchain component, each of the electronic devices can understood as a node in the blockchain network.

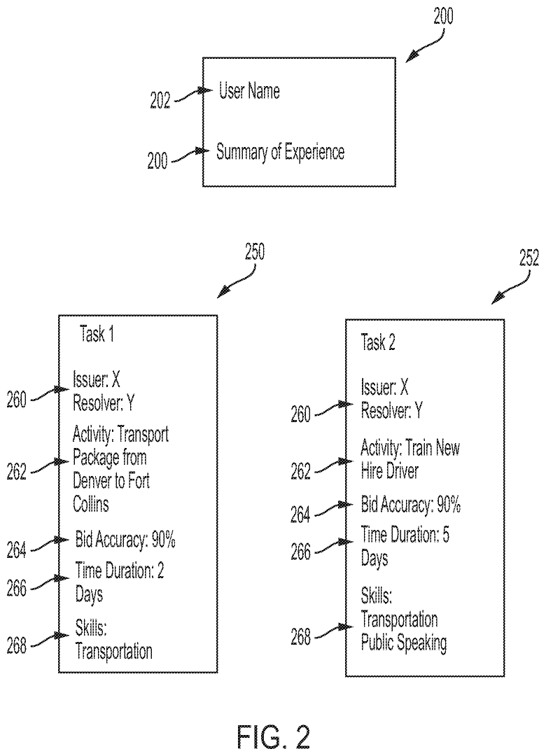

FIG. 2 illustrates an example of a data structure wherein organization records are stored based on specific tasks completed rather than as summaries of prior experience. In comparison, a conventional database, such as for resume information, allows for entries of generalized statements of prior experience. In such a conventional data entry 200, the data entry 200 for a particular user can include user information 202 and the generalized statements of prior experience 204. In contrast, data entries of the present application can be arranged by individualized tasks 250, 252. With the individually stored tasks 250, 252, specific details of the task including involved organizations 260, task activity 262, bid accuracy 264, time duration to completion 266, and specific skills gained or improved 268.

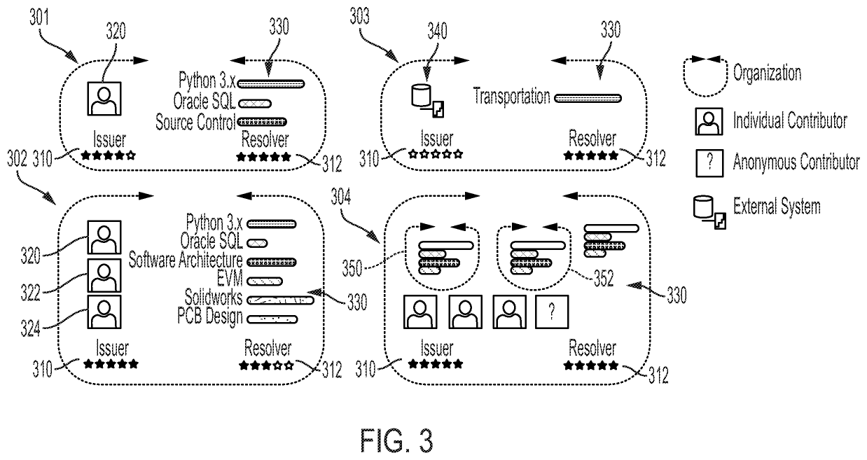

FIG. 3 illustrates a chart of four different, example organizational structures 301, 302, 303, 304 that are contemplated in the present database management system. In embodiments of the contemplated database management system, data can be attributed to organizations. The organizations 301, 302, 303, 304 can be the entities that generate content. In embodiments, an organization can be an individual, a group of individuals, an organizational entity, or combinations thereof. Additionally, in some embodiments, external systems can interface with the database management system and be represented as either an individual or an organization entity.

Organizations can create tasks in the database management system, which can be understood as an ecosystem, as well as resolve the created tasks of itself or other organizations. In embodiments, an organization can act in one of the following roles during task resolution of either an issuer or a resolver. In some embodiment, the database or records of the ecosystem can be understood as being stored in a blockchain. Some embodiments utilizing a blockchain can also be understood as being achieved by way of non-transitory computer readable medium or conventional storage medium, such as a hard drive. For illustrative purposes of establishing a trustless system for the database, implementation of recordings keeping is provided with reference to blockchain methodologies.

In the ecosystem, an issuer can be understood as an organization that creates a task in the ecosystem. A resolver can be understood as an organization that fulfilled the task in the ecosystem.

In order to track organization competency in relation to the tasks in the ecosystem, various parameters of an organization can be tracked in the ecosystem. The parameters can include skills, reviews by issuers, and bid accuracy.

Regarding skills, when a task is completed by an organization it is published to the ecosystem or blockchain. The specific skills required for the task can be logged to the resolver organization and can be used to represent the organization's domain-specific capabilities for future tasks.

Regarding reviews by users, after a task has been completed, the participating organizations of the issuer and the resolver can be prompted to review each other. Organizational reviews can be published to the blockchain for viewing by potential future collaborators. The organization reviews can allow for textual inputs to provide a holistic experience of interacting with the other organization beyond performance metrics.

Regarding bid accuracy, this performance metric of a resolver organization can provide an evaluation of its bids on tasks relative to their actual completion duration for previous projects. In the ecosystem when bids can be submitted for particular tasks, this can provide issuer organizations with actual past performance data for a particular resolver organization's bid rather than blindly relying on the bid estimation. In embodiments, the bid accuracy can be further evaluated by tasks or projects utilizing particular skills.

In some embodiments, organizations in the ecosystem can act in a separate role, that of oversight or supervisor. The role of oversight can be part of the task created by the issuer, such that the resolver's progress is monitored by a third organization. This may be useful in situations where the issuer has limited experience in the skills of the task, and wishes to have another experienced organization provide verification of the quality of work according to generally accepted practice in the industry of the skills.

FIG. 3 illustrates example representations of how an organization in the ecosystem can be understood. An individual organization 301 can be understood as being an individual contributor 320, or single individual. Information related to the individual contributor 320 can be stored as a profile. For example, educational background, age, gender, hobbies, and previous career positions can be stored information. The individual organization 301 can have data corresponding to a rating value as an issuer or tasks 310 and a rating value as a resolver of tasks 312. The rating values as an issuer 310 and as a resolver 312 can be star ratings or numerical ratings. For example, the rating values can be based on a scale of a maximum of five stars. The individual contributor 320 can also have a listing of skills and experience level 330 of the skills stored in the ecosystem. In this way, the individual contributor 320 can have relevant information available in the ecosystem for the purposes of issuing and resolving tasks.

An organization of multiple individuals 302 can be understood as a collective of individual contributors represented as a single organization. The collective of individual contributors can be stored under the single organization and affiliated 320, 322, 324. Information related to the individual contributors 320, 322, 324 can be stored as a profile. For example, educational background, age, gender, hobbies, and previous career positions can be stored information. The organization of multiple individuals 302 can have data corresponding to a rating value as an issuer or tasks 310 and a rating value as a resolver of tasks 312. The rating values as an issuer 310 and as a resolver 312 can be star ratings or numerical ratings. For example, the rating values can be based on a scale of a maximum of five stars. In some embodiments, the rating values may be only for the organization of multiple individuals 302. In other embodiments, the rating values may be calculated from the ratings of the individuals or both the organization and the individuals. For example, an averaging method can be used. The organization of multiple individuals 302 can also have a listing of skills and experience level 330 of the skills stored in the ecosystem that is the sum of the skills of the individuals within the organization. In this way, the organization of multiple individuals 302 can have relevant information available in the ecosystem for the purposes of issuing and resolving tasks.

An external system organization 303 can be understood as an organization or external system that is added or initially separate from the ecosystem. By interfacing with the ecosystem, the external system organization 303 can interact with the ecosystem similarly to an individual contributor or individual organization 301. In some embodiments, the external system organization can be limited to only act as a task resolver. The external system organization 303 can have data corresponding to a rating value as an issuer or tasks 310 and a rating value as a resolver of tasks 312. The rating values as an issuer 310 and as a resolver 312 can be star ratings or numerical ratings. For example, the rating values can be based on a scale of a maximum of five stars. The external system organization 304 can also have a listing of skills and experience level 330 of the skills stored in the ecosystem. In this way, the external system organization 303 can have relevant information available in the ecosystem for the purposes of issuing and resolving tasks.

A mixed organization 304 can include a plurality of organizations 350, 352 and/or individual contributors 320, 322, 324. This organizational structure provides for the ability to form large teams. In embodiments, the mixed organization represents the sum of the skills of its children, or plurality of organizations and/or individual contributors.

Information related to the individual organizations 350, 352 and contributors 320, 322, 324 can be stored as a profile. For example, educational background, age, gender, hobbies, and previous career positions can be stored information. The mixed organization 304 can have data corresponding to a rating value as an issuer or tasks 310 and a rating value as a resolver of tasks 312. The rating values as an issuer 310 and as a resolver 312 can be star ratings or numerical ratings. For example, the rating values can be based on a scale of a maximum of five stars. In some embodiments, the rating values may be only for the mixed organization 304. In other embodiments, the rating values may be calculated from the ratings of the individual organizations 350, 352 and contributors 320, 322, 324, or both the organization and the individuals. For example, an averaging method can be used. The mixed organization can also have a listing of skills and experience level 330 of the skills stored in the ecosystem that is the sum of the skills of the individuals within the organization. In this way, the mixed organization can have relevant information available in the ecosystem for the purposes of issuing and resolving tasks.

In some embodiments of the ecosystem envisioned in the present application, industry standard concepts as well as those instituted by the City of Zion Foundation can be used to aid in defining the ecosystem for globally optimal employment from both an employee and an employer perspective. In embodiments, the Neo Blockchain framework can be used. In embodiments, a network of trustless resumes can be deployed to anchor the ecosystem, which can include global task match-making services and analytical project management as further described below.

In the ecosystem, a task is a base unit of work, or atomic unit of work. Tasks have a value assigned to them which is dependent on their value to the issuer. The value can be in terms of currency or terms of remittance. A task can be comprised of a combination of activities or a collection of tasks.

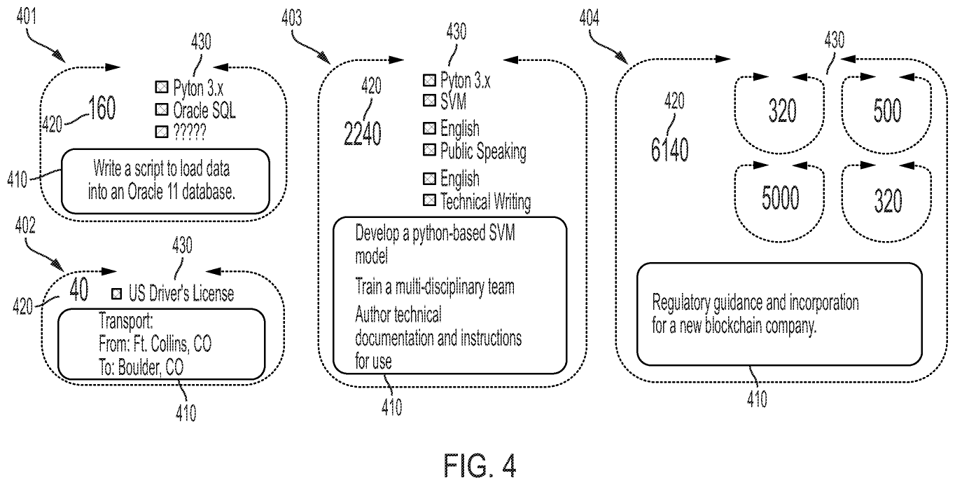

FIG. 4 illustrates example representations of how tasks in the ecosystem can be understood. A single activity task 401, 402 can relate to an issuer requesting a singular activity. In an example of a single activity task 401, the activity 410 of the task is to write a script to load data. The task 401 has a value 420 of 160 units of currency. The task 401 can also have a list of desired or required skills for any perspective resolvers. In another example of a single activity task 402, the activity 410 of the task is to transport something from one location to another. The task has a value 420 of 40 units of currency. The task 402 has a listed skill for a driver's license. Tasks can also have multiple activities or action requirements. Multiple activity tasks 403 can require the completion of multiple activities 410 for a resolver to be awarded the value 430 of the task. Each of the activities can have different skills 430 desired or required for the perspective resolvers.

Still, there can be grouping tasks 404 which represent a collection or grouping of tasks, each with their own value. Grouping tasks 404 can be used to implement larger projects or activities 410. With grouping tasks 404, the total value of the task is the sum of the values of its child tasks. In embodiments, the resolver can be awarded the value of each individual child task as it is completed to the issuer's satisfaction. This can allow for the resolvers to be paid over the course of the project rather than only at final completion of the grouping task 404.

Generally, it can be ideal for issuers to keep activities in a task to a practical number. When determining the scope of an individual task, uncertainty can be introduced by increasing task sizes due to currency volatility for the given value and estimation accuracy, which tends to degrade with increasing task size.

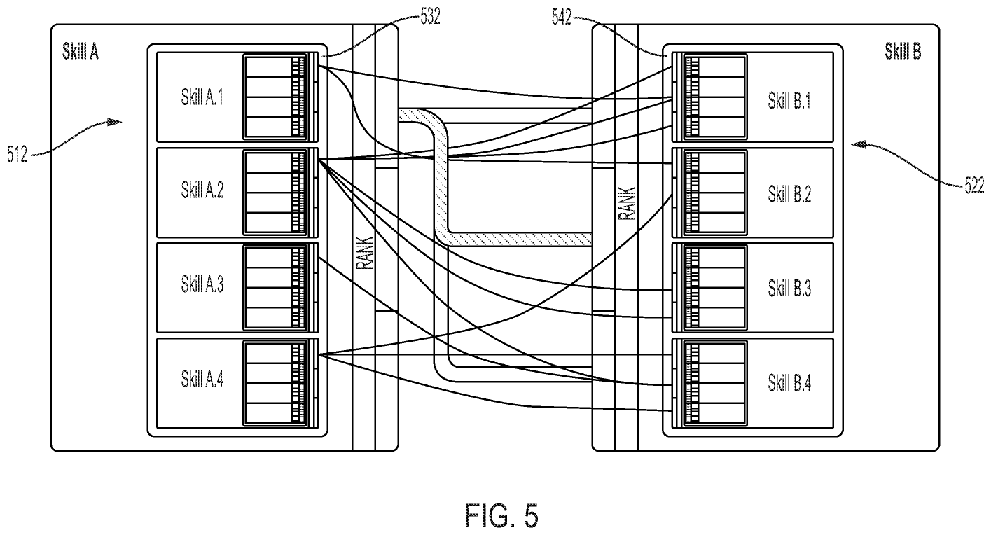

FIG. 5 illustrates a simplified diagram showing a ranked hierarchical network for skills. Skills in the ecosystem are critical as integration points between issuers and resolvers in the ecosystem. Skills serve to help resolvers identify potential tasks of interest and also help to define the experience of organizations on their trustless resumes in the ecosystem. As organizations resolve tasks in the ecosystem, they can accumulate points in particular skills based on the completed tasks. The points can be scaled by a number of criteria including their review by the issuer and the task's value.

In the example illustrated in FIG. 5, a high proficiency 532 in a sub-skill 512 of one skill can correspond to be related to a moderate proficiency 542 in a sub-skill 522 of a second skill. A ranked hierarchical network can provide a skills hierarchy representing a scoped relationship between skills, with nested skills having a narrower scope. Edges in the network can be reinforced through the issuing and completion of tasks to build a relational model between all of the skills represented in the ecosystem. The relational model can be sensitive to the skill-level of the resolver. Edges can provide accurate task duration estimates in the ecosystem as they improve the size of the dataset which can be drawn from.

For potential resolvers to find tasks of interest, a marketplace can be provided. The marketplace can be a scoped task backlog. It can provide a match-making service for issuers and resolvers. When publishing a task to the marketplace, issuers can choose where the task is made available. For example, in embodiments, the task can be scoped globally, locally, or organizationally.

With global scoping, a task can be made available to all resolvers. The resolvers can be on a mainnet and privatenets within the marketplace. The mainnet can be visible for all organizations in the marketplace. Privatenets can be used internally in organizations or a collection of organizations, separate from the mainnet. Global scoping can provide the most potential resolvers at the expense of information security since potential resolvers must be able to review a task prior to bidding.

With local scoping, a task can be made available to resolvers on a same network as the issuer. Local scoping can be useful to limit information of the task within a privatenet for particular corporate settings. This can provide increased security of information compared to global scoping.

With organizational scoping, the issuer can select specific organizations to be eligible for bidding as resolvers. In this way, the issuer can selectively limit the spread of information of the task to particular organizations. This can allow for vetting of the resolver organizations. Additionally, by repeatedly using a select number of organizations, the resolver organizations can take advantage of tribal or institutional knowledge from historical activities on similar tasks or interfacing with the issuer organization. Organizational scoping can be particularly beneficial on larger tasks or in fields requiring highly specialized skills.

With the marketplace, a match-making process can match resolvers with particular tasks. Issuers can assign a level of competency to the skill required for an identified skill for a task. In embodiments, required skills as well as activities of the task can be censored from public view for security purposes.

Of course, new users looking for tasks without any experience in the skill will have difficulty in initially using the marketplace without accommodation by the system. Various mechanisms can be used to promote match-making with these new users to help them gain experience in the ecosystem in the skill.

The marketplace does not necessarily prevent users from finding and placing bids on tasks for which they do not have the required skills of the task. Instead, this can allow for the new user to place competitive bids in terms of time duration in order to offset their lack of experience.

Separately, the database system can allow for unverified off-chain experience information for initial entry.

In some embodiments, the organization must have the information provided by particular external systems, serving as strategic partners or verifiers. This can be allow for a way to define experience and skillsets prior to accumulating trustless resume information in the ecosystem.

In some embodiments, organizations can be incentivized to audit the tasks of others and can recommend additional skills, improvements to the task activity definition, and modification to the value of the task.

In embodiments, the match-making process or algorithm can be built into a Smart Contract in the blockchain to provide resolvers with task recommendations based on the resolver organization's skills. In embodiments, the match-making process or algorithm can be off-chain from the blockchain and stored in memory of an electronic device. The match-making process or algorithm can be part of the program code for the database management of the ecosystem or a separate program code. Access to the match-making algorithm by external systems can be provided through a public application programming interface (API).

Upon task completion, the issuer and the resolver can each provide a review of the other. The resolver organization's experience gain can then be used to update the resolver organization's record in the blockchain for match-making with future tasks. In embodiments, the experience gain can have a scalar applied to it that is correlated to the review they received from the issuer and the value of the task completed. The review issuer and the skills of the task can be stored on the blockchain for verification and reference by others.

In cases where an organization is made up of multiple organizations or individual contributors, resource channeling can be used to allocate experience to the team members. A variety of resource channeling methods can be used depending on organizational settings.

In an embodiment utilizing administrator assignment, an administrator in the resolver organization can directly allocate the gained skills and funds to the various members of the organization. This may be allocated according to a prior agreement by the members of the organization during formation, before bidding, or as part of their agreement in bidding on the task.

In an embodiment utilizing voting, the members of the resolver organization can vote on how they wish to distribute skills and funds amongst the members of the resolver organization. In some embodiments, only some of the members of the resolver organization may have voting rights, as agreed upon during formation of the organization.

As organizations continue to exist in the ecosystem, the allocation can then be maintained until future deliberation within the resolver organization.

When a resolver organization finds a task that it is interested in, the organization can bid on the task through the marketplace.

In some embodiments, the bidding can be done in terms of value, such as currency. In such an embodiment, if the resolver organization believes that a task value assigned by the issuer is undervalued or overvalued, the resolver organization can place a bid with what it believes is a fair value for the task. In this way, the ecosystem can allow for self-correction of task valuation.

In some embodiments, the bidding can be done in terms of task duration. The task duration can be based on the resolver organization's estimate of real time to complete the task or based on traditional full time employee (FTE) hours. In the real time based task duration, this means that if a task is expected to take three days to close out and the task begins on a Monday, then the task will be projected to be completed at the end of Wednesday. From the various task durations provided by different bidders, the issuer organization can make a final selection based on necessary or desired task durations.

Bid accuracy can be relatively volatile and can be highly correlated to subject matter expertise and the task duration. A countermeasure that can be requiring that resolver organizations provide a three point task duration estimate, with high, low, and expected task duration. This information can be used to calculate a project buffer and a project manager buffer to account for schedule volatility due to estimation inaccuracy.

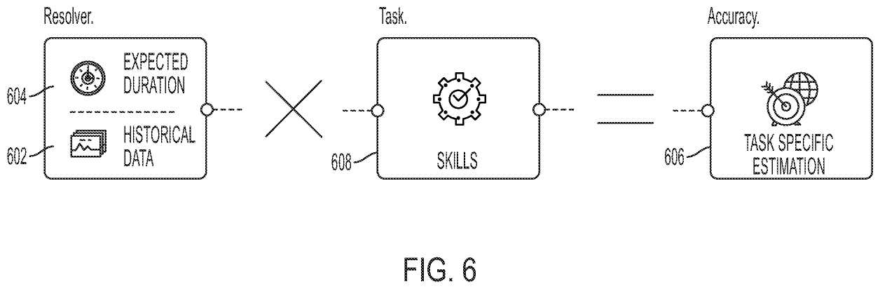

FIG. 6 illustrates a representation of how the ecosystem can aid in evaluating the resolver organization's estimate in the task duration. The ecosystem can retrieve historical data 602 regarding the resolver organization's bid accuracy from prior bid task duration estimates and actual task duration upon completion. The ecosystem can then look to the resolver organization's bid estimate task duration 604 for the task to determine a more accurate estimation 606 or buffer. In some embodiments, the level of proficiency in a particular skill 608 by the resolver organization can also be factored into the estimation or buffer 606, wherein higher proficiency in a particular skill can lower or narrow the range of the estimation or buffer 606.

In some embodiments, the data relating to the organizations and their skills are stored in the blockchain. In other embodiments, the tasks resolved by the organizations are also stored in the blockchain.

To incentivize more resolver organizations to bid on a particular task, the issuer organization can increase their value of the task, as in increase the currency value of the task. By increasing the value of the task, resolver organizations may be more likely to submit lower duration bids, implying that the resolver organization will assign a higher priority to the task in order to meet the lower task duration. Additionally, a higher value may provoke bids from more experienced resolver organizations in addition to yielding more aggressive, shorter task duration bids. In combination with reviews of past work by other issuer organizations and bid accuracy analysis, there will still be controls against resolver organizations providing unrealistic task durations.

In some scenarios, where historical data in the database is limited or disagrees with the bids from the resolver organizers, the bid accuracy and projection of completion of a task can be difficult to determine. In such a situation, the database management system may choose to provide the bid as a pass-through estimate. The system can provide a designator to indicate that there is not enough data to provide an improved estimate for completion. In some embodiments where not enough historical data is available, the system can use a derived bid accuracy using historical data from similar skills.

With a low value task, an issuer may receive fewer bids from resolver organizations but can focus on minimizing costs. An experienced resolver organization may bid on multiple low value tasks and only spend a fraction of their available time on the tasks. In doing so, they are incentivized to provide a longer, accurate bid task duration, reflecting the additional time compared to if the task was valued for more time allocated to the project immediately. In this way, there are potential opportunities for less experienced organizations to provide more competitive bids to gain experience in the skills of the task.

As part of the value proposition of a task, in some embodiments, issuer organizations can modify the task value, as well as other attributes of the task such as activities and skills required. In some embodiments, the issuer organization can modify the task until a first resolver organization bids on the task or until assignment of the task to a resolver organization.

In embodiments, resolver organizations can see the bids of other resolver organizations for a particular task. This can provide task competition, by allowing crashing through rebidding on a task with a more competitive estimate.

Upon review of the bids from resolver organizations, the issuer organization can select a particular bid as a winner and assign the task to the resolver organization. Selection of the bid can represent an agreement between the issuer organization and the resolver organization to complete work defined in the task for the defined compensation, including task value, skills experience update, and a review. Selection of the resolver can be done manually or can be automated by the resolver organization.

With manual selection, the issuer can review the resolver's bid and experience prior to awarding the task. This can be especially useful for critical or high value tasks.

With automated selection, the resolver organization with the closest match to particular criteria established by the issuer organization. For example, criteria may involve size of the resolver organization, closest match to ideal task duration, or other parameters. This can allow for the issuer to skill and bid thresholds as conditions for automated selection of a review, with the task being immediately awarded if a bid meets the threshold criteria.

In some embodiments, the issuer organization can set particular tasks as being either manually or automatically awarded based on perceived importance to the issuer organization.

In generating information for the organizations in the ecosystem, there can be considered two components, conventional resume information and trustless resume information. Conventional resume information can be supported for introduction of an organization into the ecosystem. The external, unverified experience of the organization can be provided for initial entry. In some embodiments, the organization must have the information provided by particular external systems, serving as strategic partners or verifiers. This can be necessary to allow for a way to define experience and skillsets prior to accumulating trustless resume information in the ecosystem.

Trustless resume information is related to the tasks issued and resolved within the ecosystem. Each task as resolved in the ecosystem can be published to the blockchain to build up the resolver organization's trustless resume. The task information can be structured for use in applications of the ecosystem. It is considered a cleaner dataset than conventional resumes due to its means of nucleation. In some embodiments, trustless resume information can be integrated to the blockchain from specific verified sources to provide an entry point for new organizations to the ecosystem.

In some embodiments, conventional resumes can be represented by way of distinctive representation to denote that it is not trustless resume information. For example, if displaying organization information as part of a graphical user interface, the skills and reviews can be denoted by a different color to indicate information provided outside the ecosystem. As the organization gains experience and reviews in the ecosystem, the organization's ratings will then take into account its performance on tasks in the ecosystem.

One significant risk with any ecosystem driven by peer reviews is false bolstering of organization credentials. In the database management system of the present application, this false bolstering can arise if an organization is able to publish fake tasks and resolve them internally. The organization can use the task value to republish tasks, and thereby gain the skills of the task and the positive reviews in the ecosystem without actually having the proficiency indicated by the task history of the organization. On a smaller level, false bolstering can also be done by the addition of skills to a task that are not actually representative of the work done in the task.

To defend against potential false bolstering, the ecosystem can utilize countermeasures to dissuade false bolstering. For one, the growth of skill of an organization can correspond to a task value, wherein the higher the task value the higher the skill gain. This application will deter the usage of free tasks in an attempt to bolster a resume.

Additionally, the necessity of having a high task value is a deterrent as the ecosystem can collect a proportional fee based on the task value, so the organization will necessarily incur a cost if it attempts to do false bolstering.

Also, algorithms can be implemented to search through the organizations and tasks to identify fraudulent tasks used for false bolstering. For example, an algorithm can identify particular resolver organizations that only have completed tasks from fraudulent issuer organizations that do not award tasks to any other resolve organizations.

Ultimately, required user reviews can serve as a means to prevent fraud. When an organization falsely bolsters its abilities, it will eventually receive a poor receive upon being awarded a real task. Poor user reviews from real tasks will ultimately filter out the falsely bolstered organizations at the expense of those few tasks.

As part of task issuing and resolution, multiple distinct remittance, or payment, strategies can be implemented. All of the different remittance strategies can be implemented, with the issuer organization selecting the desired remittance strategy, or only a select number of the remittance strategies can be implemented. The ecosystem may default to one remittance strategy as a default.

Postpay can be one remittance method. With postpay, remittance can be handled after the task has been completed. In embodiments, at least one of the reviews by the issuer organization or the resolver organization has been completed. By tying the reviews to remittance, the ecosystem can also aid in guaranteeing that reviews are submitted for the purpose of establishing the organizations reputations.

Prepay can be another remittance method where the payment for a task is immediately released when the task is awarded to the resolver organization. This can be useful in cases where funds are required to complete the task or if the task is initiating a new project. Avoidance of task completion can be regulated by the impact to the resolver organization's reputation through the review process.

Staked remittance can be another method, wherein the method of payment for work completed on a task is contingent on the completion of other tasks. For example, in a case where a task includes an initial coin offering (ICO) where payment is in the form of the to-be-issued coin, the issuer organization can stake the project with another form of payment. If the ICO project is successful, then the issued coin is received by the resolver organization. However, if the ICO project fails to issue tokens within a time-frame defined by the staking process, the alternative form of payment is used for remittance instead. This can provide a level of insurance and guarantee of compensation for working on new ventures by resolver organizations. Staked remittance can effectively provide crowdfunding through services and minimize the risk to resolver organizations while also providing project visibility in the ecosystem.

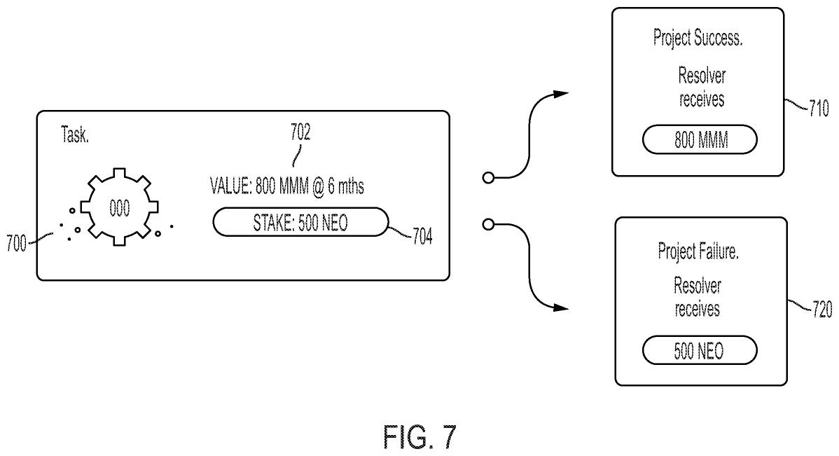

FIG. 7 illustrates an example representation of a staked remittance task. In the staked remittance task 700, the remittance is set at with a payment value 702 of 800 tokens of MMM at six months after completion of the task. However, it has a staked payment 704 with 500 tokens of NEO if the MMM token is not available at the end of six months. As such, if the MMM token project is a success and the MMM token issues within six months, the resolver organization receives remittance in terms of MMM tokens 710. However, if the MMM token project is a failure, the resolver organization receives remittance in terms of the NEO tokens 720.

Flex remittance can be similar to postpay with the exception that the compensation amount is undefined until after the task has been completed. In order to encourage bids on the task, issuer organizations will need to define specific compensation criteria, such as hourly pay, bonuses for quality deliverables, and payment by word-count on authored blog articles.

Periodic remittance can be payment on regular interval while the resolver organization is actively assigned to the task. The regular interval payments can be defined by the issuer in the task prior to task assignment. The periodic remittance can be done for a set period of payments or it can extend to the completion of the project.

In the course of task creation and assignment, organizations may have concerns with sensitive information.

Identity management can be provided in order prevent bias in hiring and advancement. Ethnicity, age, sex, and academic merit are sources of friction for hiring purposes. Whether intentional or not, bias can be exhibited in the professional space, even subconsciously.

In some embodiments, the ecosystem can provide resolver organizations with the option of obfuscating personal information from the task issuer at an attribute level. Similarly, issuer organizations can choose to obfuscate personal information from the resolver organizations bidding on the task at the attribute level. Additionally, in some embodiments, the organization itself can choose to obfuscate its own personal information. This can allow organizations to guarantee objectivity in resolver selection. However, in some cases where verification of identity must be required by the issuer, a resolver organization choosing to obfuscate personal information may not be eligible.

In some scenarios, the description of a skill for the task may contain sensitive information. For these situations, the issuer may choose to censor the label of a task skill. In some situations, the skill may be hidden to the resolver organization. However, by using the hierarchal nature of skills in the ecosystem, the closest parent skill with which the resolver organization can visibly see will be displayed.

In some situations where there is extreme concern for data breach, an organization can choose to run its own private network, or privatenet, to guarantee security. In embodiments, the database management can include running on the private network with a cross-chain service being required to resolve any external applications. An off-chain service can be provided for directionally controlled, selective synchronization of data between the public mainnet and privatenets running the database management system.

This can allow for secure control of data within the organization while still providing the ability to selectively collaborate with other privatenets or other organizations in the mainnet globally. In embodiments, task information and other data sent to the mainnet can be write-only and can include a designator to indicate the privatenet origination to control potential misrepresentation or contamination of the mainnet skills and reviews.

In some embodiments, the database management system can implement a private blockchain in the privatenet for the organization. In embodiments of a private blockchain, the organization can issue and resolve tasks internally, similar to inter-organization tasking in the mainnet, but maintain all of these records in the private blockchain. In some embodiments, the records of the private blockchain can be synchronized to the public mainnet. In this way, organizations can utilize the database management for internal purposes only to record tasks without interaction with other organizations.

In providing the ecosystem where issuer organizations and resolver organizations can be efficiently matched, it is important to have a good task quality. The ecosystem can provide subjective enforcement of task quality by providing publicly available issuer reviews. Additionally, the task quality can be controlled by recommendations and review bounties.

With recommendations, historical data from the ecosystem can provide issuer organizations with expectations of their tasks prior to presenting the task for bidding in the marketplace. By referencing the skills and contents of the task, the database management system can calculate a recommended task value as well as expected yield results for task duration.

With review bounties, issuer organizations can stake a review bounty on their tasks. If a review bounty is staked on the task, other organizations can review the task and propose revisions to the task, such as enhanced documentation, clarification requests, value modifications, and required skills changes. The review bounty can be set such that multiple organizations can review the task and collect a portion of the review bounty. In some embodiments, review bounties can be public requests open to all reviewing organizations. In some embodiments, the issuer organization can request review by specific organizations.

In order to allow for the ecosystem to grow its userbase, two application programming interfaces (APIs) can be provided. In a Smart Contract API, a publicly defined interface to the ecosystem can be available for use by external systems and applications. The Smart Contract API can provide core functionality like match-making, bidding, and task issuance. The Smart Contract API can also include supplemental functionality for standardization of the ecosystem with external systems. In embodiments, the Smart Contract API can be configured to enhance the utility of other smart contracts operating on the Neo Blockchain. In a Web API, an externally accessible web API can also be available to external systems and applications to provide core functionality and extended platform support.

In some embodiments of the ecosystem, issuer organizations can assign task dependencies, which can allow for complex task structures. As individual tasks can be made up of a collection of tasks, task dependency can provide scalability and range in degrees of detail on a project. For example, an issuer organization can have three tasks with dependencies, within which, a number of other tasks are defined.

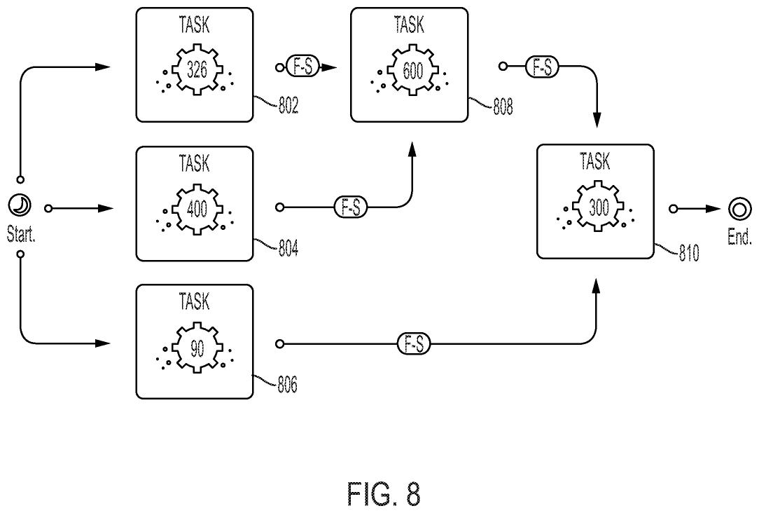

FIG. 8 illustrates a representation of an embodiment where tasks can be optionally assigned relationships with other tasks to form a network diagram 800. In embodiments, the issuer organization can form the network diagram 800 with relational timing of tasks relative to one another. For example, a first task 802, a second task 804, and a third task 806 can all be concurrently started. However, a fourth task 808 has a start dependent on the finishing or completion of the first task 802 and the second task 804. A fifth task 810 can have a start dependent on the finishing or completion of the fourth task 808 and the third task 806. Through mapping of the relationships of the tasks in the network diagram 800, the total time duration across the tasks can be tracked.

When multiple bids on a task are received, the issuer can review each bid to select the most appropriate one for their overall needs.

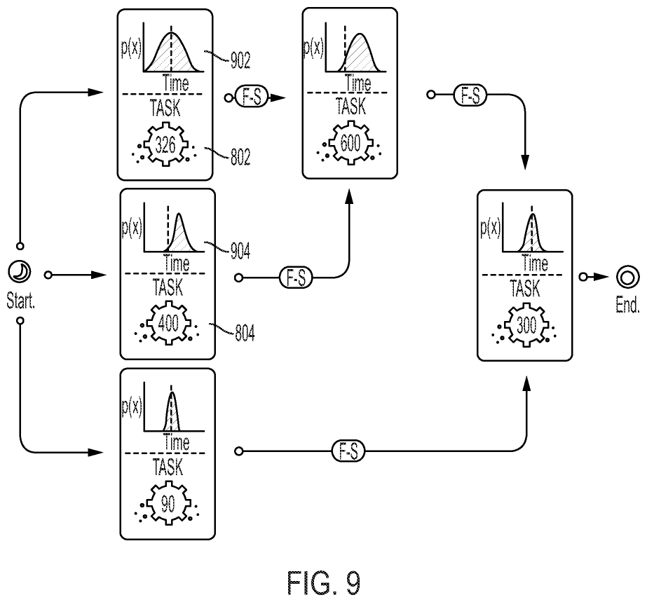

FIG. 9 illustrates a representation of an embodiment where a simulation can be provided for the expected completion time of the critical tasks. In some embodiments providing a graphical representation or display output to the user, the simulation can provide a graph 902, 904 corresponding to each task 802, 804, the graph providing a bid accuracy or probability range of completion according to time duration for the task. In this way, an issuer organizer can use the various tasks to project a distribution for expected completion time of critical task milestones.

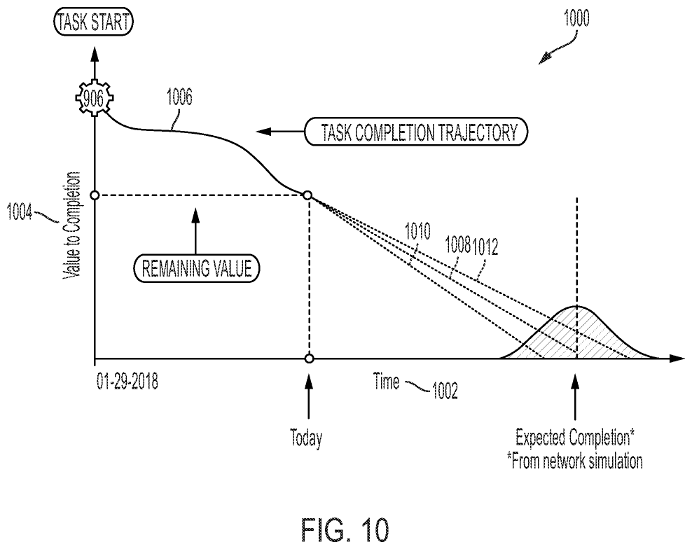

FIG. 10 illustrates a representation of projections of the results of the simulation of FIG. 9 as a burndown plot. In some embodiments providing a graphical representation or display output to the user, the burndown plot 1000 can plot the time 1002 to remaining value 1004 of the tasks in a network of tasks. The burndown plot 1000 can include the completed or historical progress 1006 on the network of tasks up to the present day. The burndown plot 1000 can then include at least one projection 1008 of a task completion trajectory to expected completion. In some embodiments, the burndown plot 1000 can also include a low duration projection 1010 and a high duration projection 1012, which can correspond to 25^{th} and 75^{th} percentile projections based on the historical bid accuracy of resolver organizers.

By relating a group of tasks in network of tasks, the issuer organization can see how resolver organization choices on particular tasks in the network of tasks can affect the expected completion date. In this way, the issuer organization can contemplate how it wishes to allocate task values across the tasks based on the expected completion of the network of tasks. In embodiments where individual task assignments are not locked until assigned to a resolver organization, the issuer organization can continually optimize downstream tasks based on upstream tasks in the network until optimized. For example, the issuer organization may wish to minimize the expected duration of the tasks at an increased cost, reduced prevision of the completion date, or quality of results.

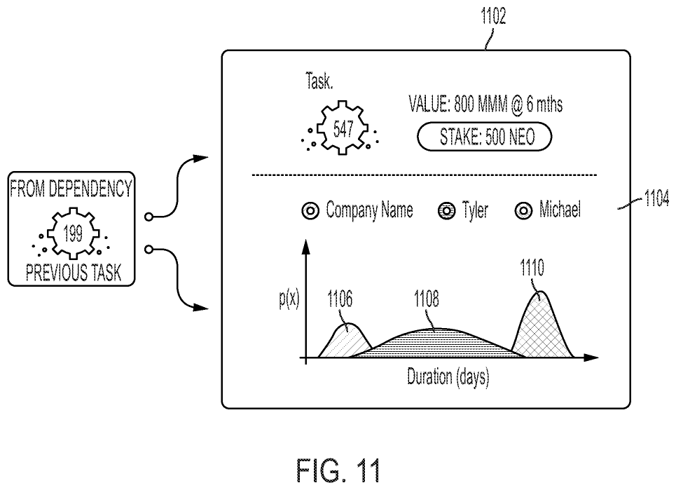

FIG. 11 illustrates a representation of multiple bids and the associated time task durations of the bids for a task. Each of the task durations can be overlaid on a plot showing estimated completion time and bid accuracy relative to time. As an illustrative example, for a given task 1102 with a task value of 547, three bidders can each be presented by their estimated task duration and bid accuracy. The first bidder company can be presented by a first plot 1106, the second bidder, Tyler, can be represented by a second plot 1108, and the third bidder, Michael, can be represented by a third plot 1110. In embodiments providing a graphical representation or display output to the user, the issuer organization can easily view the options regarding task staffing by comparing the options presented by the various bids from resolver organizations.

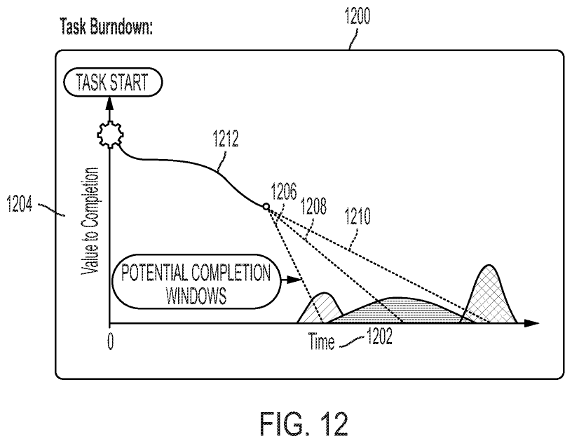

FIG. 12 illustrates a representation of multiple bids for a task, as in FIG. 11, reflected in projections of a simulation as a burndown plot. In embodiments providing a graphical representation or display output to the user, the burndown plot 1200 can plot the time 1202 to remaining value 1204 of the tasks in a network of tasks. The burndown plot 1200 can include the completed or historical progress 1212 on the network of tasks up to the present day. The burndown plot 1200 can then include a projection track 1206, 1208, 1210 corresponding to each of the bids to expected completion.

With such a graphical representation in the burndown plot 1200, the issuer organization can see how the resolver organization choice on the particular task in the network of tasks can affect the expected completion date. In this way, the issuer organization can contemplate how it wishes to allocate task values across the tasks based on the expected completion of the network of tasks. In embodiments where individual task assignments are not locked until assigned to a resolver organization, the issuer organization can continually optimize downstream tasks based on upstream tasks in the network until optimized. For example, the issuer organization may wish to minimize the expected duration of the tasks at an increased cost, reduced prevision of the completion date, or quality of results.

Accordingly, combinations and variations of the above graphical representations and other types of graphical representations can be understood to be generated from data from tasks and bids. Accordingly, the database management system can also include the building of dashboard applications to provide support for various project management strategies as may be desired by the issuer organization. Additionally, through utilization of APIs, organizations can develop their own project tracking applications from the data from tasks and bids from the database management system.

Additionally, the database management system can include a way to review and improve operations of an organization with regards to issuing and resolving tasks.

For resolver organizations, it is important to monitor resource allocation to tasks in order to ensure timely completion. Allocation or commitment to too many tasks can result in a schedule slip, which will negatively affect the organization's estimation bid accuracy as well as the reviews for those tasks from issuer organizations. The database management system can provide tools to generate graphical representations or reports to the resolver organization of allocations as monitoring tools. In embodiments, the database management system can also present data or statistics on how tasks open for bidding can impact utilization of the resolver organization. For example, if the resolver organization has historical data of schedule slip after taking on a particular number of tasks or an aggregate of tasks having a cumulative task value, the system can inform the resolver organization whether a task open for bidding would put the resolver organization under, at, or above the historical threshold for schedule slip.

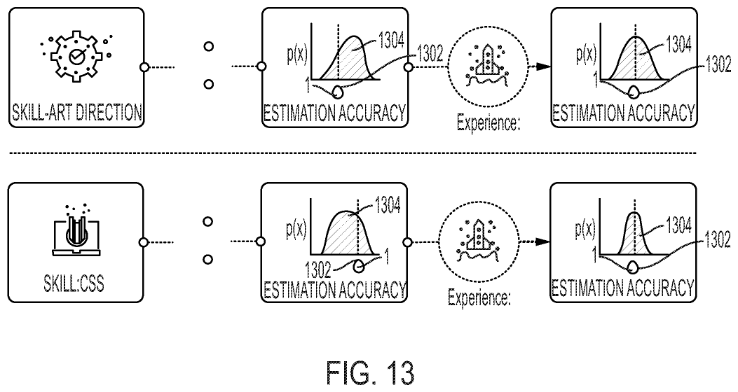

FIG. 13 illustrates a representation of how resolver organizations can review their skill specific estimation bid accuracies as a mechanism for self-improvement over time. For example, a particular skill, such as art direction or CSS, can have a bid estimate 1302 and an estimation bid accuracy 1304 range. In review of the experience gained by the resolver organization and the estimation bid accuracy 1304 range, the resolver organization can adjust its bid estimate, thereby lessening its deviation from the bid estimate and improving its bid accuracy 1306 for future tasks and its future reputation.

In review of their profile in the database management software, the organizations are able to review their performance using various objective and subjective metrics collected from previous tasks. As organizations complete tasks and build up their dataset in the ecosystem, review of this trustless resume information can provide a number of benefits for future collaborators. For example, subjective reviews can provide insights into interpersonal improvements. Awarded bids and historical trends can provide estimates for revenue streams from specific skills as well as the resolver organization's future labor burden for awarded tasks, affecting allocation. Review of bid accuracy on issued tasks can identify areas of improvement for task definition requested by the resolver organization to the issuer organization prior to bidding. Also, as discussed in FIG. 13, bid accuracy by the resolver organization can be reviewed for improvements to future bid accuracy, which may improve future probabilities of being awarded tasks. Additionally, review of organizational investment by skill and time can provide insight into issuer resource allocation as well as resolver income and skill growth.

In embodiments, resolvers are able to review their estimation accuracy data when bidding on tasks as a mechanism to improve the accuracy of their bids. This introduces a bias into the estimates which allows for resolver organizations to self-correct for their bid inaccuracy. This bias can be reduced by accounting for transient changes in the estimates. As drift occurs in estimation accuracy, the database management system can apply transient filtering to guarantee that bid corrections track with the current accuracy of the resolver organization.

As organizations using the ecosystem actively develop skills, it is expected that their estimation accuracy distributions asymptotically approach an expected value of 1 for the skills. Error associated with estimate precision may not be removed from the ecosystem, but can be substantially reduced by clear task definition by the issuer organization.

In some embodiments, the database management system can provide methods for crowd funding projects through tasks. Embodiments can allow for project accountability and transparency to stakeholders by using the mechanics built into the ecosystem. For example, one method of crowd funding can be accomplished where an issuer organization is created for the issuers or contributors. The issuers can represent the project stakeholders, both investors and developers. Tasks can be created by the issuer organization to represent maturity gates, which a project must complete to unlock funding via a remittance mechanic. As members are added to the issuer organization, the can stake the maturity gate tasks with currency. Depending on the task, the issuers can stake specific tasks they view as important to the overall project. When the project matures to meet maturity gates defined in the tasks, the project stakeholders can vote on their completion to release funds to the resolvers. Alternative remittance mechanisms can be used to provide different funding strategies for the project.

In regards to monetization of the database management system, or generating revenue streams, at least three ways to monetize the system can be envisioned. Additional monetization methods can be contemplated.

With a Remittance monetization structure, the ecosystem can charge a fee on task completion. In embodiments, the fee can be a flat fee or proportional to the value of the task transaction. In embodiments, a portion of the fee can be used to cover exchange fees in the event that the issuer organization's payment is not in the preferred currency of the resolver organization. In some embodiments, the issuer organization or the resolver organization can pay for all of the fees. In some embodiments, the fee can be split between the issuer organization and the resolver organization.

With a Platform Contracts monetization structure, the ecosystem can provide subscription based products and services. The subscription based products and services can provide organizations with access to the database management system. In some embodiments, the organizations can be provided with access to a global mainnet and a global blockchain. In some embodiments, the subscription based products and services can provide for an internal privatenet and/or a private blockchain.

With a Platform as a Service monetization structure, the ecosystem can provide hardware and administration of privatenets. In embodiments, all data read and written to a database utilizing such a platform can be controlled by the service owner. Platform as a Service can provide for an internal privatenet as well as a private blockchain, including generation of a genesis block for the private blockchain.

In embodiments of the ecosystem, a token can be used for remittance and currency. Usage of the token can result in reduced system fees.

In view of the preceding, the database management system can be implemented on a blockchain platform with a modular contract architecture. Each contract can add distinct value to the blockchain platform and integrate with the other contracts.

All of the above described graphical plots and diagrams relating the tasks to estimates can be generated by the database management system.

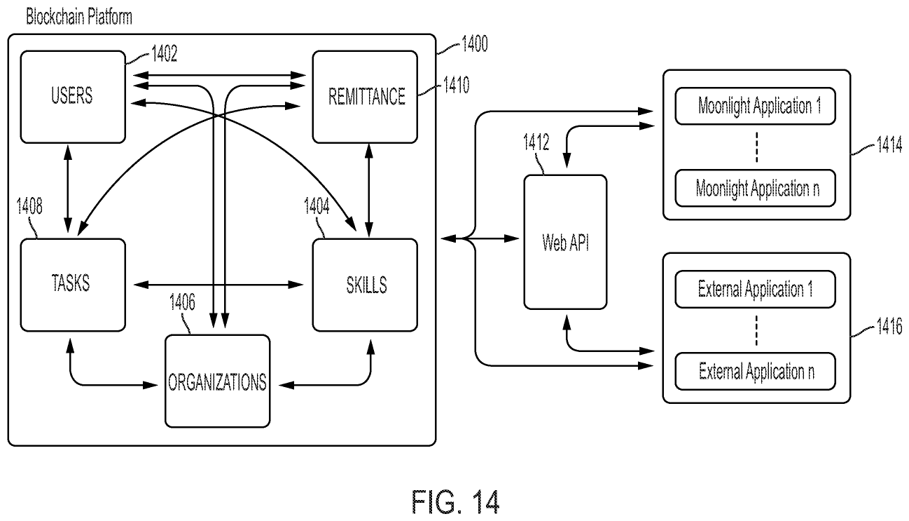

FIG. 14 illustrates an example representation of the modular contract architecture of a blockchain platform for the ecosystem described. The modular contract architecture 1400 can include a user account contract 1402, a skills contract 1404, an organization contract 1406, a projects tasks contract 1408, and a remittance contract 1410.

The user account contract 1402 can be responsible for storing information related to users of the database management system, including their profile data and skill associations. Users can have some control regarding the visibility of particulars of their information to the public. As such, any publicly identifiable information can be encrypted using a private key and only available via an API pending verification of the user's preferences.

The skills contract 1404 can define a skill that an organization can have within the ecosystem. Skills can be defined during initial entry to the ecosystem and by organizations within the ecosystem as tasks are completed. Skills can belong as a subset of another skill, thereby creating a hierarchy or categorization of skills in the ecosystem. Organizations can also have the ability to define the visibility of their custom skills.

The organization contract 1406 can define information related to an organization. The information can include organizational hierarchy, employees and their roles, default payment structure for a contract, and public visibility of information. An organization can have a rating defined by the ratings and experiences of its individual users or contributors. In some embodiments, the organization can have an independent rating from its individual users or contributors.

The projects contract 1408 can be responsible for the creation and curation of a task in the ecosystem. The task can belong to or be related to another task allowing for the creation of a workflow or a project hierarchy. A task can be defined by a type of bidding process, task funding and payout criteria, a progression and completion mechanism, and links to resolver organizations interacting with the task.

The remittance contract 1410 can allow issuer organizations and resolver organizations to define and agree upon the payout criteria and payment structure for tasks they are involved with.

The contracts can be interfaced with through an API 1412 with either ecosystem specific applications 1414 or external system applications 1416.

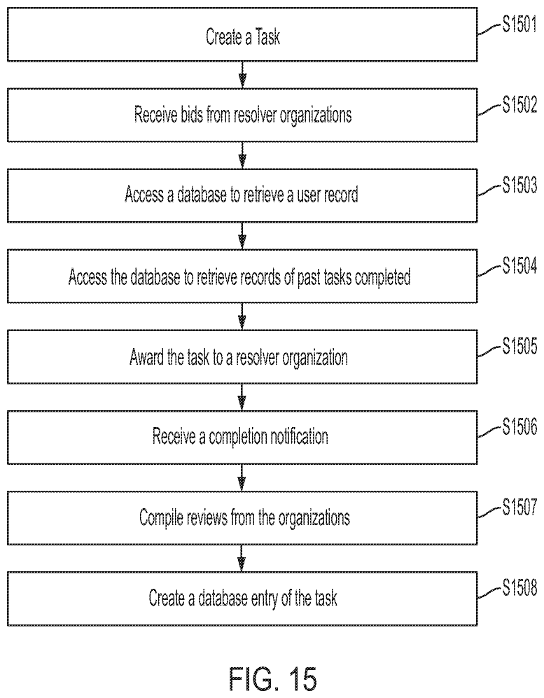

In view of the foregoing description of the ecosystem and tasks, FIG. 15 illustrates a flowchart as to how a database management system can provide the desired database structuring. The specific structure of the database based by task provides an improvement in accessibility to review specific skills in relation to actual work performed.

In step S1501, the database management system can create task. The task can have at least one of an associated currency value, necessary skills to resolve the task, and a description of activity to be undertaken for the task.

In step S1502, the database management system can receive bids from resolver organizations for the created task. The bids can include at least one of an estimated time duration to completion and an associated currency value.

In step S1503, the database management system can access a database to retrieve a user record or profile of a resolver organization.

In step S1504, the database can be accessed to retrieve records of past tasks completed by the resolver organization. In embodiments, the database can be stored in the form of a blockchain.

In step S1505, the database management system can award the task to a resolver organization.

In step S1506, the database management system can receive a completion notification that the task has been completed by the resolver organization.

In step S1507, the database management system can compile reviews from an issuer organization of the task and the resolver organization.

In step S1508, the database management system can create a database entry of the task and its associated data, including bidding information, time duration to completion, the reviews by the organizations, and other pertinent information. The database entry of the task can be associated with the issuer organization and the resolver organization. In embodiments, the database entry can be stored as part of a block in a blockchain based database. With the blockchain database, the entry cannot be altered or tampered with after the block is added to the blockchain database.

As understood, embodiments can include only some of the steps of FIG. 15, in various combinations and order arrangements. The steps do not necessarily need to occur in the sequential order.

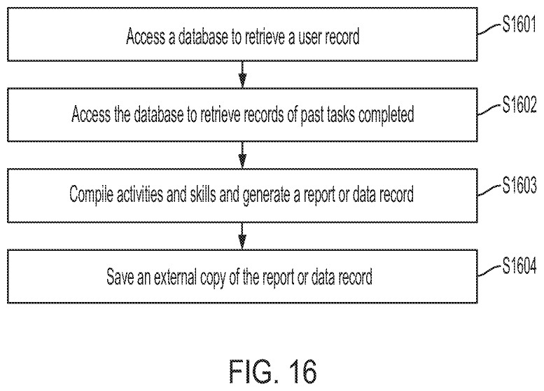

FIG. 16 illustrates a flowchart of how potential employers can also access the database management system to review the experience of a user. This can be useful in hiring of potential candidates.

In step S1601, a database can be accessed to retrieve a user record or profile of a targeted user. In some embodiments, an API can be utilized by an external application.

In step S1602, the database can be accessed to retrieve database entries of past tasks completed by the targeted user. In embodiments, the database can be stored in the form of a blockchain. The database entry of the task can include associated data, including bidding information, time duration to completion, reviews by the organizations involved in the task, and other pertinent information.

In step S1603, the external application can compile the activities and skills from the past tasks resolved by the targeted user and generate a report or data record.

In step S1604, the external application can save an external copy of the report or data record.

In embodiments, software or applications as part of the database management system can include user tracking through the various tasks on stored on the blockchain. Each of the completed tasks stored in the blockchain can include a particular designator for of the issuer organization and the resolver organization. When an organization has multiple contributors, a particular designator can be provided for each of the multiple contributors. In this way, analysis of the tasks records in the blockchain can provide user tracking through identification of the designator of the targeted user.

Additional applications similar to work tasks can be understood from the present application. For example, student academic records can also be stored in a database or blockchain. In such a case, course information and grades for a particular student can stored in the blockchain as entered by the university, with the enrolled course corresponding to the task. In this way, additional experience, e.g. course and grade information, can be added to the blockchain as the student continues their education. Furthermore, the blockchain can provide a secure storage ability that cannot be modified or tampered with by the student, as a paper transcript or even a digital copy of the transcript might be susceptible.

Methods of creating, updating, and storing a database, such as the skillset verification records in a blockchain, are considered within the scope of the present invention.

Embodiments of the application can provide a system for verification of skills of a user based on tasks. The system can include at least one processor configured to execute computer-readable instructions; and a non-transitory computer readable storage medium storing computer-readable instructions that when executed by the processor cause the processor to perform steps. The steps can include generating a task for bidding by at least one user, the task including skills requirements; receiving at least one bid from the at least one user; accepting one of the at least one bids as an accepted user of the at least one user; indicating completion of the task; and updating of the skills of the accepted user with the skills requirement of the task upon completion of the task.

Embodiments of the application can provide a method for verification of skills of a user based on tasks, performed by a database management system, to be performed by at least one processor and at least one non-transitory computer-readable medium to provide the database management system. The method can include generating a task for bidding by at least one user, the task including skills requirements; receiving at least one bid from the at least one user; accepting one of the at least one bids as an accepted user of the at least one user; indicating completion of the task; and updating of the skills of the accepted user with the skills requirement of the task upon completion of the task.

Although limited embodiments of databases have been specifically described and illustrated herein, many modifications and variations will be apparent to those skilled in the art. Accordingly, it is to be understood that the databases and blockchains constructed according to principles of the disclosed devices, systems, and methods may be embodied other than as specifically described herein. The disclosure is also defined in the following claims.

What is claimed is:

1. A database management system for organizing and storing task information, the system comprising:
at least one processor configured to execute computer-readable instructions; and
at least one non-transitory computer readable medium to provide a database management system, the database management system directed to perform steps comprising:
generating a task for bidding by a resolver;
receiving a bid from the resolver;
retrieving data corresponding to previous tasks completed by the resolver from a database;
accepting the bid from the resolver;
assigning the task to the resolver;
receiving indication of completion of the task;
creating a data entry in the database corresponding to the task containing information relating to its completion.

2. The database management system according to claim 1, wherein the database is a blockchain.

3. The database management system according to claim 1, wherein the task comprises at least one of a task value for completion, a listing of specific activities to be performed, and required skills for completion of the task.

4. The database management system according to claim 3, wherein the bids can include at least one of an estimated time duration to completion of the task and a task value requested by the resolver to accept the task.

5. The database management system according to claim 4, wherein the data corresponding to previous tasks includes bidding information, a time duration to completion, a review of the resolver, and skills gained or improved by the task.

6. The database management system according to claim 5, wherein the data entry in the database corresponding to the task includes bidding information, a time duration to completion, a review of the resolver, and skills gained or improved by the task.

7. The database management system according to claim 6, wherein the data entry includes a unique identifier to denote the resolver for user tracking when analyzing a blockchain.

8. The database management system according to claim 3, wherein the data entry uniquely corresponds with the task.

9. The database management system according to claim 2, wherein the database management system can access the blockchain through an application programming interface (API).

10. The database management system according to claim 9, wherein the database management system can compile activities and skills data from the data corresponding to previous tasks completed by the resolver; and
wherein the database management system can generate a report or data record and save the report or data record to an external memory.

11. A method for organizing and storing task information, generated by a database management system, to be performed by at least one processor and at least one non-transitory computer-readable medium to provide the database management system, the method comprising:
generating a task for bidding by a resolver;
receiving a bid from the resolver;
retrieving data corresponding to previous tasks completed by the resolver from a database;
accepting the bid from the resolver;
assigning the task to the resolver;
receiving indication of completion of the task;
creating a data entry in the database corresponding to the task containing information relating to its completion.

12. The method according to claim 11, wherein the database is a blockchain.

13. The method according to claim 11, wherein the task comprises at least one of a task value for completion, a listing of specific activities to be performed, and required skills for completion of the task.

14. The method according to claim 13, wherein the bids can include at least one of an estimated time duration to completion of the task and a task value requested by the resolver to accept the task.

15. The method according to claim 14, wherein the data corresponding to previous tasks includes bidding information, a time duration to completion, a review of the resolver, and skills gained or improved by the task.

16. The method according to claim 15, wherein the data entry in the database corresponding to the task includes bidding information, a time duration to completion, a review of the resolver, and skills gained or improved by the task.

17. The method according to claim 16, wherein the data entry includes a unique identifier to denote the resolver for user tracking when analyzing a blockchain.

18. The method according to claim 13, wherein the data entry uniquely corresponds with the task.

19. The method according to claim 12, wherein the database management system can access the blockchain through an application programming interface (API).

20. The method according to claim 19,
wherein the database management system can compile activities and skills data from the data corresponding to previous tasks completed by the resolver; and
wherein the database management system can generate a report or data record and save the report or data record to an external memory.
